(19) United States
(12) Patent Application Publication
(10) Pub. No.: US 2021/0243070 A1
(43) Pub. Date: Aug. 5, 2021

(54) SWITCH PORT PROTECTION MECHANISM

(71) Applicant: Hewlett Packard Enterprise Development LP, Houston, TX (US)

(72) Inventors: David Kasperson, Austin, TX (US); Robert Teisberg, Austin, TX (US); Alexander Kramer, Plano, TX (US); Charles Greenidge, Fort Collins, CO (US); Frederick Kuhns, Austin, TX (US); Neil Gierman, Austin, TX (US); Adriano Gonella, Austin, TX (US)

(21) Appl. No.: 16/778,113

(22) Filed: Jan. 31, 2020

(51) Int. Cl. H04L 12/24

(52) U.S. Cl. CPC H04L 41/0654; H04L 41/0604

(57) ABSTRACT

A system to facilitate identification of intermediate switches within a network switching fabric is described. The system includes a processor and a machine readable medium storing instructions that, when executed, cause the processor to detect a neighbor change event at a switch port of a network switch, determine whether a switch port neighbor device coupled to the switch port is trusted, set a status of the switch port as failed upon a determination that the switch port is untrusted, block network traffic through the switch port and generate an alert indicating that untrusted switch port neighbor device is coupled to the switch port.

### BACKGROUND

Data centers provide a pool of resources (e.g., computational, storage, network, etc.) that are interconnected via a communication network. In modern data center network architectures a network switching fabric typically serves as the core component that provides connectivity between the network resources, and facilitates the optimization of server to server (e.g., east-west) traffic in the data center. Such switching fabrics may be implemented using a software-defined transport fabric that interconnects a network of resources and hosts via a plurality of top of rack network (TOR) fabric switches.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates one embodiment of a system employing a data center.

FIG. 2 is a block diagram illustrating one embodiment of a network switching fabric.

FIG. 3 is a block diagram illustrating one embodiment of a fabric manager.

FIGS. 4A & 4B are flow diagrams illustrating one embodiment of a method for performing switch port protection.

FIGS. 5A & 5B illustrate embodiments switch port coupling.

### DETAILED DESCRIPTION

The connection of network resources via a switching fabric is implemented using infrastructure cabling to provide a physical connection of hardware devices (e.g., servers, storage and switches) for workload deployment of a data center. However, an improper modification of cabling is a common occurrence during the maintenance or upgrade of resources within the data center. Improper cabling may result in significant operational issues, such as outages and/or security issues due to improper server traffic on a switch, or access to networking traffic.

In embodiments, a mechanism is provided to facilitate switch port protection. In such embodiments, a determination is made as to whether a neighboring device coupled to a switch port is trusted. A first set of actions is taken upon a determination that the device is trusted. However, a second set of actions is taken upon a determination that the device is untrusted. Such actions include blocking the switch port and generating an alert.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Throughout this document, terms like “logic”, “component”, “module”, “engine”, “model”, and the like, may be referenced interchangeably and include, by way of example, software, hardware, and/or any combination of software and hardware, such as firmware. Further, any use of a particular brand, word, term, phrase, name, and/or acronym, should not be read to limit embodiments to software or devices that carry that label in products or in literature external to this document.

It is contemplated that any number and type of components may be added to and/or removed to facilitate various embodiments including adding, removing, and/or enhancing certain features. For brevity, clarity, and ease of understanding, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

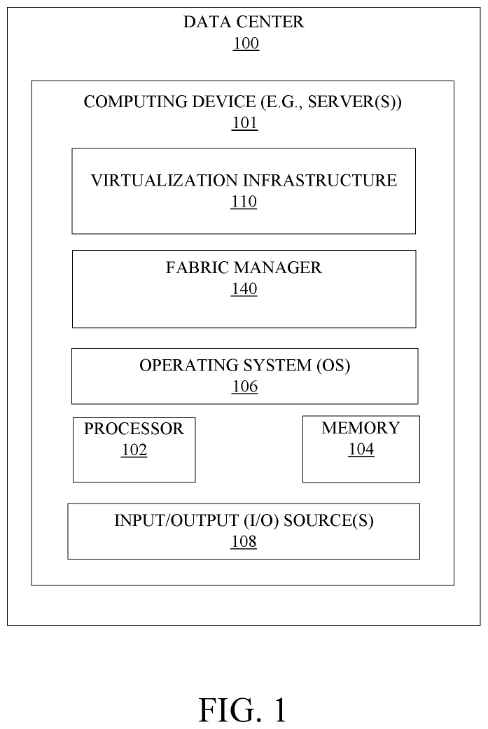

FIG. 1 illustrates one embodiment of a data center 100. As shown in FIG. 1, data center 100 includes one or more computing devices 101 that may be server computers serving as a host for data center 100. In embodiments, computing device 101 may include (without limitation) server computers (e.g., cloud server computers, etc.), desktop computers, cluster-based computers, set-top boxes (e.g., Internet-based cable television set-top boxes, etc.), etc. Computing device 101 includes an operating system (“OS”) 106 serving as an interface between one or more hardware/physical resources of computing device 101 and one or more client devices, not shown. Computing device 101 further includes processor(s) 102, memory 104, input/output (“I/O”) sources 108, such as touchscreens, touch panels, touch pads, virtual or regular keyboards, virtual or regular mice, etc.

In one embodiment, computing device 101 includes a server computer that may be further in communication with one or more databases or storage repositories, which may be located locally or remotely over one or more networks (e.g., cloud network, Internet, proximity network, intranet, Internet of Things (“IoT”), Cloud of Things (“CoT”), etc.). Computing device 101 may be in communication with any number and type of other computing devices via one or more networks.

According to one embodiment, computing device 101 implements a virtualization infrastructure 110 to provide virtualization of a plurality of host resources (or virtualization hosts) included within data center 100. In one embodiment, virtualization infrastructure 110 is implemented via a virtualized data center platform (including, e.g., a hypervisor), such as VMware vSphere. However other embodiments may implement different types of virtualized data center platforms. Computing device 101 also facilitates operation of a network switching fabric. In one embodiment, the network switching fabric is a software-defined transport fabric that provides connectivity between the host resources within virtualization infrastructure 110.

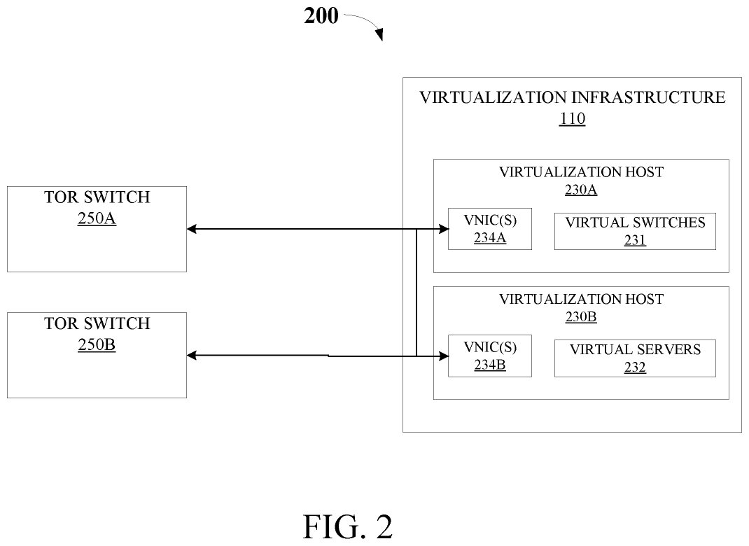

FIG. 2 is a block diagram illustrating one embodiment of a network switching fabric (or fabric) 200. As shown in FIG. 2, fabric 200 includes a plurality of top of rack (TOR) switches 250 (e.g., 250A & 250B) coupled to virtualized hosts 230 within virtualization infrastructure 110. TOR switches 250 are network switches that handle operations, including Layer 2 and Layer 3 frame and packet forwarding and data center 100 bridging.

In one embodiment, a virtualization host 230 may provide switching resources. In such an embodiment, a TOR switch 250 may be coupled to one or more virtual switches via one or more virtual network interface cards (VNICs) 234. For instance, TOR switch 250A may be coupled to virtual switches 231 via VNICs 234A within host 230A. In such an embodiment, a TOR switch 250 and switch virtualization host 230A may include a plurality of physical switching ports.

In a further embodiment, each switch port may be coupled to a neighboring device (e.g., switch port neighbors). A TOR switch 250 may also be coupled to one or more servers within a host 230 via VNICs 234. For example, TOR switch 250B may be coupled to virtual servers 233 within host 230B via VNICs 234B. In one embodiment, one or more of virtual servers (or compute units) 232 at host 230B may be coupled to virtual switches 231 at host 230A. Thus, one or more physical devices at host 230B may be switch port neighbors with switch ports at host 230A.

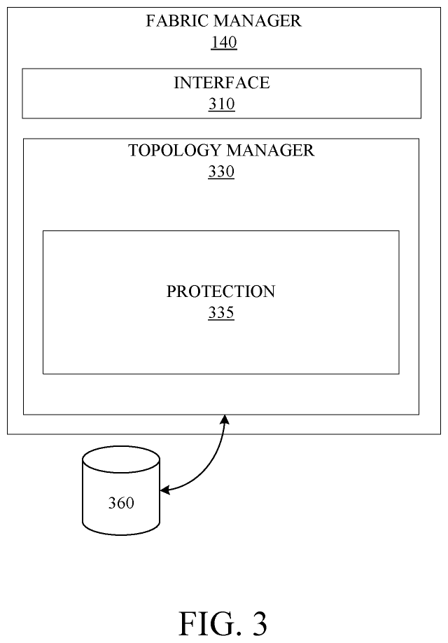

Referring back to FIG. 1, a fabric manager 140 is included within computing device to manage fabric 200. FIG. 3 is a block diagram illustrating one embodiment of fabric manager 140. As shown in FIG. 3, fabric manager 140 includes an interface 310 that is configured to communicate with virtualization infrastructure 110 regarding virtualization hosts 230. In one embodiment, interface 310 is implemented as a Representational State Transfer (REST) application program interface (API) for fabric manager 140. Fabric manager 140 also includes a topology manager 330 to manage the topology of network switching fabric 200.

In one embodiment, topology manager 330 maintains configuration details for fabric 200. In such an embodiment, topology manager 330 maintains profile connection information for each switch port. Thus, the profile connection information provides information regarding the intended connectivity between a switch (e.g., a TOR switch 250 or switch virtualization host 230) and resource (e.g., server) network adapter ports.

As defined herein, profile connection information represents profiles that include a set of connections that are assigned to specific switch port neighbors (e.g., servers). In one embodiment, each profile connection is associated with a physical switch port or a virtual port that is associated with a physical switch port. The associated physical switch port may comprise sub-ports in embodiments in which a connection utilizes virtual ports on the server side. Such switch sub-ports are also associated with a switch physical port. In a further embodiment, each connection includes networking information, such as VLANs (e.g., IEEE802.1Q) and Link Aggregation Group (LAG) (e.g., IEEE802.1AX) information. Once assigned to a server, the profile connection information is associated with the switch port and the server port at the switch port to which the server port is connected. Subsequently, the network information is configured on the switch port. Thus, once assigned to the server it is possible to determine a switch port to which each connection is associated.

According to one embodiment, topology manager 330 performs a topology analysis of switching fabric 200 upon detecting a change in a switch port neighbor. In this embodiment, a change in a switch port neighbor may occur in response to detection of a neighbor change event. A neighbor change event may occur upon detection of a cable being inserted at a switch port, or in response to a discovery of a new switch port neighbour coupled to the switch port. In a further embodiment, topology manager 330 utilizes a discovery protocol (e.g., a IEEE802.1AB) link layer discovery protocol (LLDP) data exchange, which includes data transmitted from a server port to the switch port (or from the switch port to the server port) to determine connectivity. In such an embodiment, the discovery protocol data includes the unique information identifying the port (e.g., a port physical media access control (MAC) address or the server unique ID and adapter/port, etc. for the server port and a server unique ID such as a serial number or MAC combined with a port identifier for the switch port). Topology manager 330 is configured to read this data as it is received from the switch port or server port to obtain the correlation.

In another embodiment, each end of a cable coupling a server port and a switchport neighbor may include a read only memory (ROM) that includes cable identification information that uniquely identifies the cable. In this embodiment, topology manager 330 retrieves the cable identification information from each end of the cable and compares the information to determine whether there is a match.

In one embodiment, topology manager 330 includes a switch port protection (or protection) mechanism 335 to perform the topology analysis. In this embodiment, protection mechanism 335 determines whether a device connected to a switch port is trusted or untrusted. A device determined to be trusted represents a device that has been added to network fabric manager 140 and includes a profile connection (e.g., neighbor identity and port information) that matches stored profile connection information associated with the switch port (e.g., correct device connected), while a device determined to be untrusted represents a device that has not been added to network switching fabric 200 or includes a profile connection that does not match stored profile connection information associated with the switch port (e.g., wrong device connected). In one embodiment, the profile connection information is stored at a database 360. In a further embodiment, protection mechanism 335 receives information for a switch port neighbor hardware during the discovery process described above. In such an embodiment, protection mechanism 335 retrieves the profile connection information associated with the port from database 360 and compares the profile connection information with the switch port neighbor information to determine whether there is a match.

Upon determining that a device is untrusted, protection mechanism 335 stops network traffic to the switch port and generates an alert (e.g., via a user interface) indicating that an untrusted (or unexpected) device is coupled (or cabled) to the switch port, and that network traffic has been stopped until the correct device is connected. The connection of an untrusted device may be unintentional or via malicious cable movement to obtain unauthorized access to the network. In either event, network traffic will not resume until the correct device is coupled to the switch port.

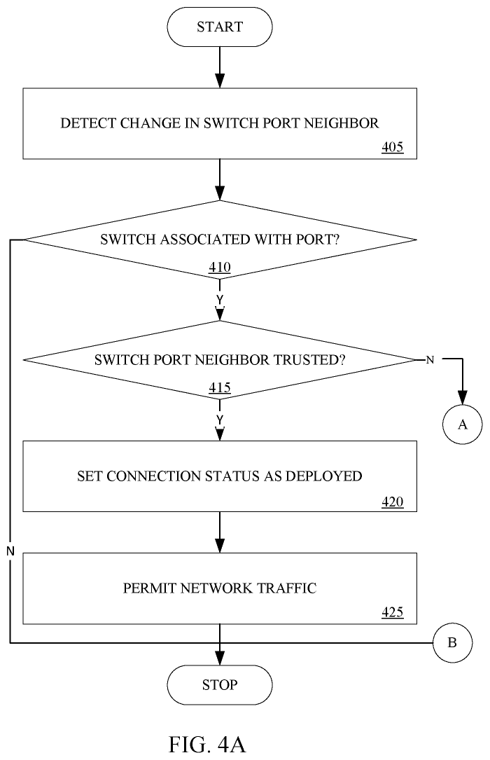

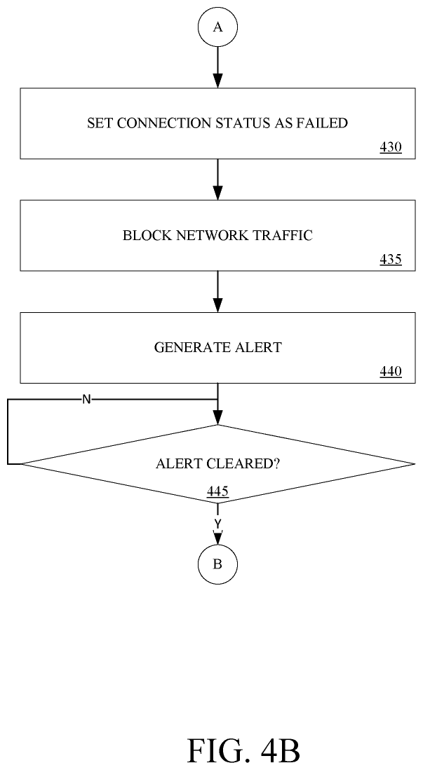

FIGS. 4A & 4B are flow diagrams illustrating one embodiment of a method for performing switch port protection. The process begins at processing block 405 (FIG. 4A) where a neighbor change event at a switch port is detected. As discussed above, a neighbor change may be detected upon detection of a cable being attached to the switch port. In such an embodiment, the detection is performed using a discovery protocol (e.g., LLDP). At decision block 410, a determination is made as to whether a switch is associated with the port (e.g., whether a switching device is assigned to the port). If not, the process is completed since there is no network traffic to the unassigned switch port.

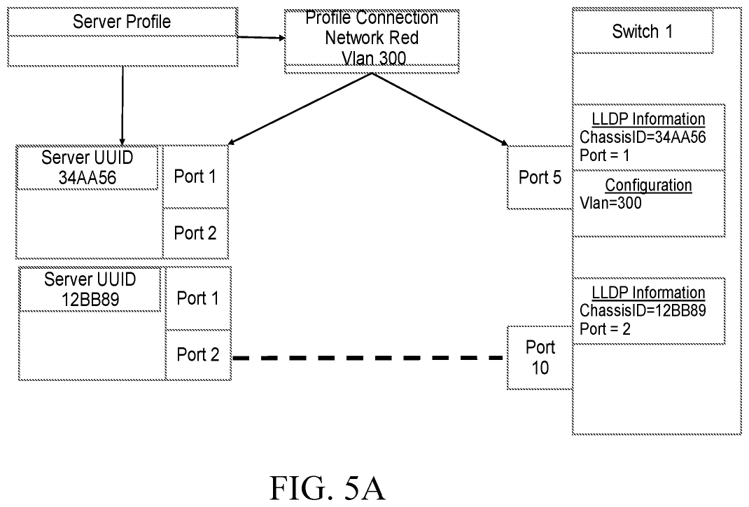

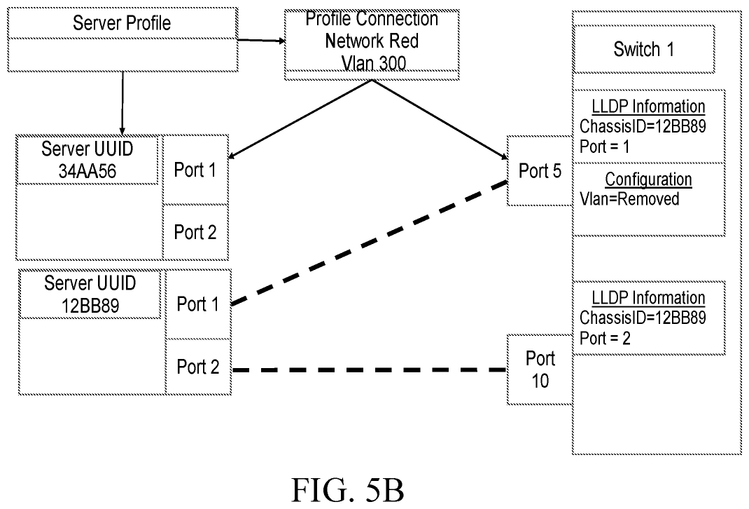

However, upon a determination at decision block 410 that a switch is associated with the port, a determination is made as to whether the switch port neighbor (e.g., device hardware) coupled via the cable is trusted, decision block 415. As discussed above, determining whether a switch port neighbor is trusted comprises a determination that the switch port neighbor hardware has been added to fabric manager 140, and the profile connection associated with the switch port neighbor hardware matches the profile connection associated with the switch port. FIG. 5A illustrates one embodiment of a trusted switch port coupling. The profile connection information for port 5 at switch 1 matches the switch port neighbor information associated with port 1 of server UUID 34AA56.

At processing block 420, a connection status for the switch port is set as deployed (e.g., active) upon a determination that the switch port neighbor is trusted. In one embodiment, the deployed switch port status is stored in database 360. At processing block 425, network traffic is permitted through the switch port via the switch port neighbor hardware. Upon a determination at decision block 415 that the switch port neighbor is untrusted, the connection status port is set as failed, processing block 430 (FIG. 4B). As mentioned above, determining whether a switch port neighbor is untrusted comprises a determination either the switch port neighbor hardware has not been added to fabric manager 140, or the profile connection associated with the switch port neighbor hardware does not match the profile connection associated with the switch port. FIG. 5B illustrates one embodiment of an untrusted switch port coupling. The profile connection information for port 5 at switch 1 does not match the switch port neighbor information associated with port 1 of server UUID 12BB89.

At processing block 435, network traffic through the switch port is blocked. In one embodiment, the switch port is blocked until there is a switch port neighbor match (e.g., a trusted neighbor is attached). In a further embodiment, the networking configuration (VLAN configurations) may be removed from the switch port when an untrusted switch port neighbor is detected to secure the network against improper access. In still a further embodiment, the networking configuration is removed without disabling the port to enable the port to continue to receive current topology information via discovery protocols. In alternative embodiments, the blocking of network traffic may be performed at the switch port neighbor hardware.

At processing block 440, an alert is generated to indicate that an unexpected device is cabled to the switch port, and that network traffic has been stopped until the correct device is connected. In one embodiment, the alert is generated at the switching device and/or the switch port neighbor hardware. At decision block 445, a determination is made as to whether the alert has been cleared. According to one embodiment, an alert may be manually generated via a fabric manager 140 user interface. In such an embodiment, an authorized operator may sign into fabric manager 140 via the user interface to clear the alert.

In another embodiment, the alert is automatically cleared upon the detection of a trusted switch port neighbor being connected to the switch port. In this embodiment, the process of FIG. 4A is repeated (e.g., with a subsequent detection of a switch port neighbor (e.g., new hardware or the same hardware that has been properly configured) through to setting the connection status as deployed in response to the detection of a trusted switch port neighbor). Once the alert is cleared, the switch port protection process has been completed (FIG. 4A).

Embodiments may be implemented as any or a combination of one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A system to facilitate protection of a switch port, comprising:
a processor; and
a non-transitory machine-readable medium storing instructions that, when executed, cause the processor to:
detect a neighbor change event at a switch port of a network switch,
determine whether a switch port neighbor device coupled to the switch port is trusted, set a status of the switch port as failed upon a determination that the switch port is untrusted,
block network traffic through the switch port, and
generate an alert indicating that untrusted switch port neighbor device is coupled to the switch port.

2. The system of claim 1, wherein the determination that the switch port is untrusted comprises the processor to execute instructions to determine that a profile connection associated with the switch port neighbor device does not match profile connection information associated with the switch port.

3. The system of claim 1, wherein the switch port remains blocked until a trusted switch port neighbor device is coupled to the switch port.

4. The system of claim 1, wherein the processor is further to clear the alert.

5. The system of claim 4, wherein the the alert is manually cleared via a user interface.

6. The system of claim 4, wherein the the alert is automatically cleared upon a detection of a trusted switch port neighbor coupled to the switch port.

7. The system of claim 1, wherein the processor sets the status of the switch port as deployed upon a determination that the switch port is trusted and permits network traffic through the switch port via the switch port neighbor device.

8. The system of claim 7, wherein determining that the switch port is trusted comprises the processor to execute instructions to determine that a profile connection associated with the switch port neighbor device matches profile connection information associated with the switch port.

9. The system of claim 1, wherein detecting the neighbor change event comprises detecting a cable attached to the switch port.

10. A method to facilitate protection of a switch port, comprising:
detecting a neighbor change event at a switch port of a network switch;
determining whether a switch port neighbor device coupled to the switch port is trusted;
setting a status of the switch port as failed upon a determination that the switch port is untrusted;
blocking network traffic through the switch port in response to the status that was set; and
generating an alert indicating that untrusted switch port neighbor device is coupled to the switch port.

11. The method of claim 10, wherein the determination that the switch port is untrusted comprises determining that a profile connection associated with the switch port neighbor device does not match profile connection information associated with the switch port.

12. The method of claim 10, further comprising blocking the switch port until a trusted switch port neighbor device is coupled to the switch port.

13. The method of claim 12, further comprising clearing the alert, wherein the the alert is automatically cleared upon a detection of a trusted switch port neighbor coupled to the switch port.

14. The method of claim 10, further comprising:
detecting a second neighbor change event at a second switch port;
determining whether a second switch port neighbor device coupled to the second switch port is trusted;
setting a status of the second switch port as deployed upon a determination that the second switch port is trusted; and
permitting network traffic through the second switch port via the second switch port neighbor device.

15. The method of claim 14, wherein determining that the second switch port is trusted comprises determining that a profile connection associated with the second switch port neighbor device matches profile connection information associated with the second switch port.

16. A non-transitory machine-readable medium storing instructions which, when executed by a processor, cause the processor to:
detect a neighbor change event at a switch port of a network switch;
determine whether a switch port neighbor device coupled to the switch port is trusted;
set a status of the switch port as failed upon a determination that the switch port is untrusted, block network traffic through the switch port; and
generate an alert indicating that untrusted switch port neighbor device is coupled to the switch port.

17. The non-transitory machine-readable medium of claim 16, wherein the determination that the switch port is untrusted comprises determining that a profile connection associated with the switch port neighbor device does not match profile connection information associated with the switch port.

18. The non-transitory machine-readable medium of claim 17, wherein determining that the switch port is trusted comprises determining that the switch port neighbor hardware has been added to a switching fabric and a profile connection associated with the switch port neighbor device matches profile connection information associated with the switch port.

19. The non-transitory machine-readable medium of claim 18, wherein a discovery protocol exchange is performed to determine connectivity between the switch port and the switch port neighbor hardware.

20. The non-transitory machine-readable medium of claim 19, wherein the discovery protocol exchange comprises data including information identifying the port and a device identifier to identify the switch port neighbor hardware.
